(19) United States
(12) Patent Application Publication
(10) Pub. No.: US 2021/0337639 A1
(43) Pub. Date: Oct. 28, 2021

(54) METHOD FOR OPERATING A MICROWAVE DEVICE

(71) Applicant: ELECTROLUX APPLIANCES AKTIEBOLAG, Stockholm (SE)

(72) Inventor: Andrea DE ANGELIS, Porcia (IT)

(21) Appl. No.: 17/268,368

(22) PCT Filed: Jul. 17, 2019
(86) PCT No.: PCT/EP2019/069299

§ 371 Date: Feb. 12, 2021

(30) Foreign Application Priority Data
Aug. 15, 2018 (EP) 18189160.7

(51) Int. Cl. H05B 6/68; H05B 6/66

(52) U.S. Cl. CPC H05B 6/686; H05B 2206/044; H05B 6/668

(57) ABSTRACT

The invention relates to a for operating a microwave device (1), the microwave device (1) comprising a cavity (2) and multiple microwave modules (3) for providing microwaves into said cavity (2), the method comprising the steps of: —providing multiple sets of operation parameters, each set of operation parameters being associated with a certain microwave module (3); •simultaneously transmitting the sets of operation parameters to the respective microwave modules (3) and synchronously applying the set of operation parameters within the respective microwave module (3) after receipt of said set of operation parameters; or •uploading the sets of operation parameters to the respective microwave modules (3) and applying the set of parameters within the respective microwave module (3) after receipt of an acknowledge command or after expiry of a certain time period.

The present invention relates generally to the field of micro-wave devices. More specifically, the present invention relates to a method for updating operating parameters of multiple micro-wave modules.

### BACKGROUND OF THE INVENTION

Microwave devices, specifically microwave ovens, are well-known in prior art. Microwaves used in microwave ovens to heat food have, typically, a frequency of 2.45 GHz. 900 MHz is an alternative frequency used for heating food. The electromagnetic waves produce oscillating magnetic and electric fields that excite water molecules in food, therefore generating heat.

For generating microwave frequency radiation, in a conventional microwave oven, high-voltage is applied to a magnetron. The microwaves are then transmitted through a waveguide to an enclosed cavity containing the load to be heated. The magnetron generates standing wave inside the cavity. Due to the fixed oscillation frequency, typically at 2.45 GHz, the energy pattern inside the microwave oven is fixed. Thus, poor cooking results are achieved because the standing wave leads to so called “hot and cold spots” inside the cavity. To overcome this issue and have more evenness in cooking process, microwave ovens includes additional solutions such as a microwave stirrer and rotating plate.

Microwave ovens using solid state technology introduce the capability to change oscillation frequency and so to vary standing wave and energy pattern inside the cavity. The usage of several microwave channels or microwave modules to direct energy into the cavity through launching devices (antennas, waveguide adapters etc.) enables further control capability. The relative phase changes between active channels lead to standing wave variations so to have different node and antinode configurations and a more uniform energy spread inside the cavity and also within the food. In order to obtain said uniform energy spread, the operating parameters of microwave modules have to be changed from time to time.

Disadvantageously, when changing the operating parameters of multiple microwave modules, undefined intermediate states may occur which lead to critical operating conditions.

### SUMMARY OF THE INVENTION

It is an objective of the embodiments of the invention to provide a method for operating a microwave device comprising multiple microwave modules which ensures a safe change of operating parameters reducing the risk of critical operating conditions due to undesired intermediate states. The objective is solved by the features of the independent claims. Preferred embodiments are given in the dependent claims. If not explicitly indicated otherwise, embodiments of the invention can be freely combined with each other.

According to an aspect, the invention refers to a method for operating a microwave device. The microwave device comprises a cavity and multiple microwave modules for providing microwaves into said cavity. The method comprises the steps of:
providing multiple sets of operation parameters, each set of operation parameters being associated with a certain microwave module;
   simultaneously transmitting the sets of operation parameters to the respective microwave modules and synchronously applying the set of operation parameters within the respective microwave module after receipt of said set of operation parameters;
or
   uploading the sets of operation parameters to the respective microwave modules and applying the set of parameters within the respective microwave module after receipt of an acknowledge command or after expiry of a certain time period (e.g. a certain number of clock oscillations).

Said method is advantageous because the take-over of operating parameters by the respective microwave modules can be synchronized or essentially synchronized leading to a reduction of undefined intermediate states.

Those operations provide the technical advantage that the transition (in which the modules are not aligned with the desired working point) is minimal and so undefined states are avoid or minimized in which one module is working with the previous parameter and other modules are working with the new parameters or vice versa. This situation may lead to a disruptive effect on the microwave modules (channels) or an overstress due to the energy that flow back in the microwave modules in the non-verified state potentially out of the “safe operation area”

Another advantage of avoiding or minimizing the transition states is the repeatability of cooking process due to the fact that the modules are working in the wanted condition and delivering the wanted amount of energy with the desired energy profile in the cavity.

According to an embodiment, the set of operation parameters comprise frequency information, phase information, amplitude or amplification information and/or ON/OFF-status information.

According to an embodiment, said uploading of sets of operation parameters to the respective microwave modules is performed in a sequential way. In other words, the operation parameters are uploaded to the microwave modules one after another. Thereby, for example a serial communication line or a data bus can be used for said upload operation.

According to an embodiment, the uploaded sets of operation parameters are buffered within the respective microwave module. Thereby the operation parameters can be stored in the microwave module as long as a command is received for applying said operation parameters.

According to an embodiment, the acknowledge command is transmitted via serial communication channel or data bus. Thus the acknowledge command may be, for example, a binary word which is specifically reserved for synchronization purposes.

According to an embodiment, the acknowledge command is transmitted via a trigger line or synchronization line reserved for synchronization purposes. For example, the trigger line or synchronization line may be a dedicated line reserved for transmitting acknowledge commands or other synchronization information. Said acknowledge command may be, for example, a change of voltage applied to the trigger line or synchronization line. Thereby, a high synchronization of parameter change is obtained.

According to an embodiment, the acknowledge command initiates a take-over-routine within two or more microwave modules, wherein an uploaded set of operation parameters is applied within a microwave module.

According to an embodiment, transmission power of the microwave modules is reduced before applying the set of operation parameters and transmission power of the microwave modules is increased after applying the set of operation parameters. Thereby, a safe parameter change can be obtained.

According to an embodiment, the microwave device comprises a master control entity and said master control entity receives information from one or more microwave modules, said information indicating that the microwave modules are ready for taking over the sets of operation parameters. Thereby, the receipt of operating parameters by the respective microwave modules and preferably also the reduction of transmission power can be monitored by the master control entity.

According to an embodiment, after applying the sets of operation parameters, the microwave modules monitor the channel reverse power at a reduced power level. Thereby it is possible to determine whether the new sets of operating parameters lead to safe operating conditions of the microwave device.

According to an embodiment, information regarding the channel reverse power is transmitted towards a master control entity. Thereby the master control entity is able to monitor the channel reverse power of all microwave modules and can decide whether safe operating conditions (channel revers power below a certain threshold; total revers power (sum of all channel revers powers) below a certain threshold value) are obtained when using the new sets of operating parameters. The decision may be made based on a mathematical model or any other decision scheme.

According to an embodiment, the master control entity evaluates information regarding the channel reverse power from different microwave modules and initiates an increase of output power of the respective microwave modules to target output power if said evaluated information indicates that channel reverse powers of the microwave modules are below a certain threshold value. Thereby, the master control entity is able to control the increase of transmission power of the microwave device to nominal power.

According to another embodiment, the master control unit may directly apply sets of operation parameters which are known to fulfil given operation conditions without decreasing power and parameter evaluation.

According to an embodiment, the master control unit initiates the transmission of further sets of operation parameters to the microwave modules if evaluated information indicates that at least one channel reverse power is above a certain threshold value. Thereby, a set of operating parameters can be rejected if unsafe operating conditions occur.

According to a further aspect, the invention relates to a microwave device. The microwave device comprises a cavity and multiple microwave modules for providing microwaves into said cavity. The microwave device further comprises a control entity configured to perform the following steps:
providing multiple sets of operation parameters, each set of operation parameters being associated with a certain microwave module;
   simultaneously transmitting the sets of operation parameters to the respective microwave modules and synchronously (e.g. after expiry of a certain time period or a certain number of clock oscillations) applying the set of parameters within the respective microwave module after receipt of said set of parameters;
or
   uploading the sets of operation parameters to the respective microwave modules and applying the set of parameters within the respective microwave module after receipt of an acknowledge command or after expiry of a certain time period (e.g. a certain number of clock oscillations).

The term “set of operation parameters” may refer to a set comprising a single operation parameter or multiple operation parameters.

The term “essentially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows an example embodiment of a microwave device of solid-state type with multiple microwave channels;

FIG. 2 shows an example implementation of a microwave channel;

FIG. 3 shows a block diagram of a microwave device comprising multiple microwave channels; and

FIG. 4 shows a block diagram illustrating method steps performed during updating operation parameters of multiple microwave modules of a microwave device.

### DETAILED DESCRIPTION OF PREFERRED EMBODIMENTS

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

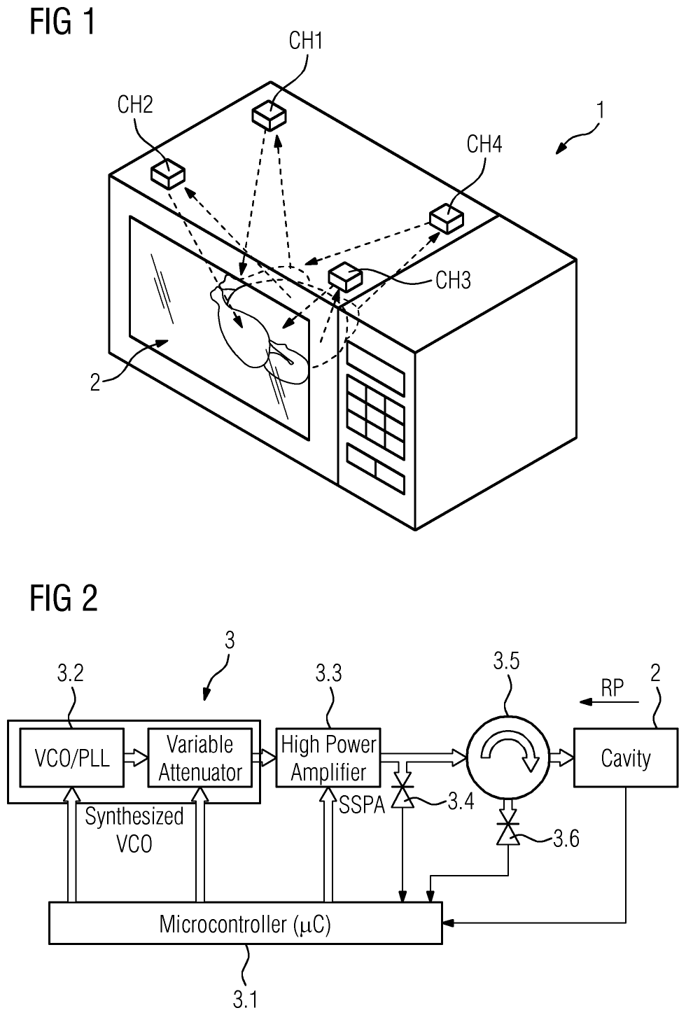

FIG. 1 illustrates a schematic diagram of a microwave device 1. The microwave device 1 may be a microwave oven for heating food. The microwave device 1 comprises a cavity 2. Microwaves can be generated within the cavity 2 by means of microwave modules, wherein each microwave module corresponds to one microwave channel CH1-CH4. In the present embodiment, the microwave device 1 comprises four microwave channels and therefore also four microwave modules. However, said number of microwave modules is only a mere example and the invention should not be considered limited to such number of microwave modules. More generally, the microwave device 1 may comprise two or more microwave modules. As already mentioned before, the microwave device 1 may be of solid-state type, i.e. the microwave channels are adapted to change the frequency of provided microwaves in order to vary the energy pattern inside the cavity 2. Said change of frequency leads to variations of the standing wave generated within the cavity 2 and thereby a more uniform energy spread inside the cavity 2 and therefore also inside the load to be heated by microwaves.

FIG. 2 shows an example embodiment of a microwave module 3, which is coupled with an antenna which provides the microwaves generated by the microwave module 3 into the cavity 2. The microwave module 3 together with the antenna or waveguide may form a single microwave channel CH1-CH4.

The microwave module 3 comprises a control unit 3.1 adapted to control the generation of microwaves. The control unit 3.1 may, for example, include a microcontroller. More in detail, the control unit 3.1 may be adapted to influence the frequency, phase and amplitude of the microwave provided into the cavity 2. For example, the microwave module 3 may comprise a voltage controlled oscillator (VCO) 3.2 which may comprise a phase locked loop (PLL) and an attenuator for generating a HF-signal with a certain frequency, phase and amplitude. In addition, the microwave generator 3 may comprise an amplifier 3.3 in order to adapt the electric power of the HF-signal.

The control unit 3.1 may be operatively coupled with the voltage controlled oscillator (VCO) 3.2 and the amplifier 3.3 in order to generate an HF-signal with a certain frequency, phase and amplitude as desired. The control unit 3.1 may be configured to receive a set of operating parameters and generate an HF-signal according to said received operating parameters. Said set of operating parameters may comprise, for example, frequency information, phase information, amplitude or amplification information and/or ON/OFF-status information. Said frequency information is indicative for the frequency of the microwave signal. Said phase information may be indicative for the phase of the microwave signal (for example a phase relative to the microwave signal of another microwave channel). Said amplitude or amplification information may be indicative for the amplitude of the microwave signal or the amplification factor used within the microwave module. Said ON/OFF-status information may indicate whether the respective microwave channel should be turned on or turned off.

The output of the amplifier 3.3 may be monitored by a monitoring entity 3.4. More in detail, the monitoring entity 3.4 may comprise a feedback loop which provides a portion of the output signal of the amplifier 3.3 back to the control unit 3.1 or another control entity in order to check whether the output of the amplifier 3.3 fulfils given requirements.

The output of the amplifier 3.3 may further be coupled with a circulator 3.5. The circulator 3.5 may be adapted to forward the HF-signal provided by the amplifier 3.3 towards an antenna (not explicitly shown in FIG. 2) included in the cavity 2. However, the circulator 3.5 is adapted to filter out a reflected HF signal which is provided by the antenna backwards into the microwave module 3. “Filtering out” in the present case means that the reflected HF signal is blocked from traveling towards the amplifier 3.3 but is directed towards an electrical load 3.6 and/or a measurement system for measuring the reflected power. Said electrical load 3.6 is adapted to consume/absorb the reflected HF signal. Said electrical load 3.6 may be coupled with the control unit 3.1 in order to monitor the consumed/absorbed electric power of the reflected HF signal.

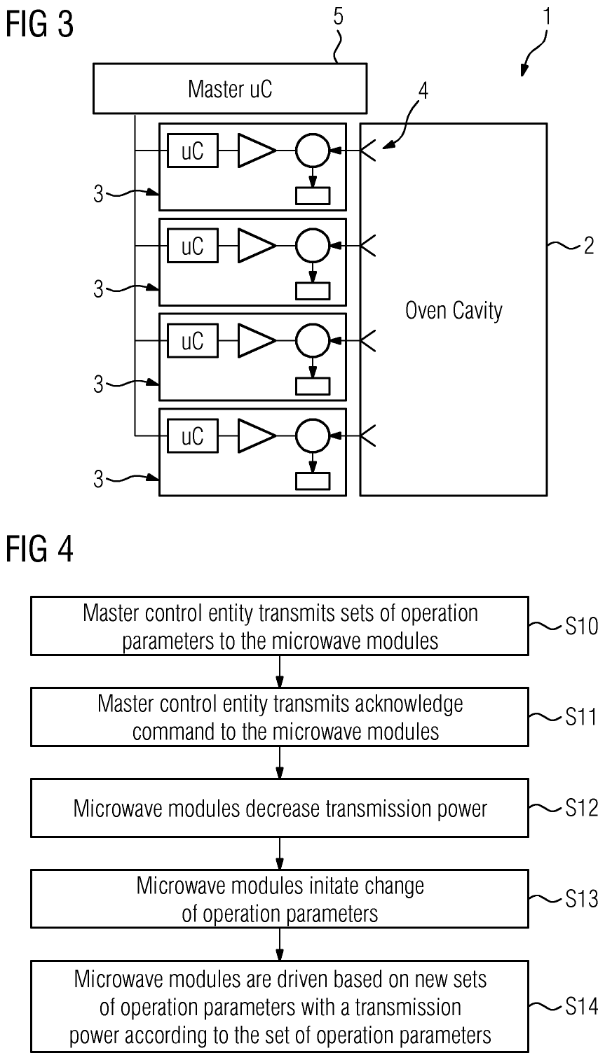

FIG. 3 shows a schematic diagram of the microwave device 1 comprising four microwave modules 3, respectively, four microwave channels CH1-CH4. Each microwave channel CH1-CH4 includes a microwave module 3 as described before in connection with FIG. 2. In addition, each microwave module 3 is coupled with an antenna 4 provided inside the cavity 2. The microwave device 1 further comprises a master control entity 5 which is adapted to control the microwave channels CH1-CH4, specifically the microwave modules 3 of the respective microwave channels CH1-CH4, as further described below.

Each microwave module 3 may be associated with a set of operating parameters which can be chosen in order to achieve a certain microwave transmission behaviour. For example, the frequency of microwaves provided by the microwave generator 3 can be chosen in a certain range, e.g. in the range of 2.4 GHz to 2.5 GHz. The step width may be 100 kHz or any other step width. Preferably, all microwave channels CH1-CH4 are operated at the same frequency, i.e. if the microwave frequency is changed, all channels change their frequency.

In addition, the phase of microwave provided by the microwave channels CH1-CH4 can be varied. For example, one channel may form the reference channel and a phase difference may be chosen between the reference channel and the other microwave channels. The phase difference may be selected in the range of 0° and 359°. The step width of phase difference may be 1° or any other step width.

Furthermore, the electrical power of the microwave provided by the respective microwave channel CH1-CH4 may be a further parameter to be selected. The electrical power may be chosen in the range between 0% and 100%, wherein 0% is power off and 100% is maximum power. The step width of electrical power may be 1% or any other step width.

A further parameter may be microwave channel ON/OFF status.

In order to fulfil certain requirements, the set of operating parameters associated with a certain microwave module can not be chosen independent of the sets of operating parameters associated with the other microwave modules because said chosen set of operating parameters of one microwave module interacts with the other microwave modules. In other words, the sets of operating parameters have to match to each other in order to fulfil certain requirements. A first requirement may be that the channel reverse power (electric power received at a certain antenna of a microwave channel and coupled back into the microwave module) is below a certain threshold value in order to avoid any damage at the microwave module. A further requirement may be that the total reverse power (i.e. the sum of all channel reverse powers) is below a certain threshold value.

In order to obtain a uniform heating within the cavity 2 without hot and cold spots, the operating parameters corresponding to a certain microwave module 3, respectively, microwave channel may be changed frequently.

When changing the sets of operating parameters in a microwave device 1 comprising multiple microwave channels CH1-CH4, a plurality of intermediate states may occur. Each intermediate state is characterized that a first set of microwave channels have already changed their operating parameters whereas another set of microwave channels have not changed their operating parameters.

When changing the operating parameters within the microwave modules, non-reliable intermediate states can occur in which the fulfilment of requirements can not guaranteed even if the start state (sets of operating parameters used by the microwave modules before change) and end state (sets of operating parameters used by the microwave modules after all changes) fulfil the requirements.

In order to reduce the risks of any non-reliable intermediate states, a method for avoiding undesired transition states during change of operation parameters in the microwave device 1 is disclosed.

The general idea is to obtain a synchronized change of operation parameters.

According to a first embodiment, a synchronized change of operation parameters at the respective microwave module 3 is obtained by a simultaneous transmission of the sets of operation parameters to the respective microwave modules 3. “Simultaneous transmission” means that the sets of operation parameters are not transmitted sequentially one after another but are transmitted concurrently. Thereby, the sets of operation parameters are received at the respective microwave modules 3 in a synchronous or quasi-synchronous way. In addition, the microwave modules 3 may be configured to immediately apply the set of parameters after receipt. Thereby a change of operation parameters at multiple microwave modules 3 is obtained with no or essentially no time delay and therefore a reduced risk of intermediate transition states. In another embodiment the change of parameters may occur after a certain time delay after the reception of the new parameters so to achieve time synchronization i.e. using the clock for the microwave generation.

According to a second embodiment, the change of operation parameters at the respective microwave modules is obtained by uploading the sets of operation parameters to the respective microwave modules. Said uploading may be obtained sequentially. The uploaded sets of operation parameters may be buffered within the respective microwave module 3. After all operation parameters have been uploaded, an acknowledge command is provided to the microwave modules 3, said acknowledge command triggering the application of said operation parameters at the respective microwave module 3. So in other words, the change of operation parameters will be executed only after receiving the acknowledge command as trigger information. The provision of the acknowledge command may be initiated by the master control entity 5.

For transmitting the acknowledge command to the microwave modules, a data transmission line coupled to all microwave modules 3 may be used. The acknowledge command will reach the microwave modules simultaneously or quasi-simultaneously (e.g. with a time delay lower than 10 ms, preferably lower than 5 ms). After receipt of said acknowledge command, the set of parameters buffered in a storage of the microwave module 3 may be applied.

The transmission of the acknowledge command may be performed via a data bus or any other data connection between the microwave modules 3. The acknowledge command may be, for example, a binary word which is interpreted by the respective microwave modules 3 and triggers the take-over of a new set of operation parameters.

According to other embodiments, a synchronization line or trigger line may be used for transmitting the acknowledge command.

Using a synchronization line or trigger line, the acknowledge command may be, for example, a change of voltage level on said line. Thereby, the synchronization of taking over a new set of operation parameters can be further improved.

In order to further increase the safety during change of operation parameters, the amplification of the microwave modules may be lowered in order to reduce the transmission power during the parameter change period.

FIG. 4 shows an exemplary flow diagram illustrating the steps performed during parameter change period.

The take-over routine of new sets of operating parameters at the respective microwave modules may be controlled by a master control entity 5 (cf. FIG. 3). The master control entity 5 may be coupled with the microwave modules 3 via a data transmission line.

In a first step, the master control entity 5 may initiate the transmission of multiple sets of operation parameters to the microwave modules 3, wherein each set is sent to a certain microwave module 3 (S10). The transmission of operation parameters may be performed sequentially or at least partially in parallel.

For example, the master control entity 5 may transmit the sets of operation parameters to target microwave modules in order to assign a certain set to a certain microwave module 3.

After receiving the set of operation parameters at the microwave module 3, the microwave module 3 may take-over the operation parameters in a buffer. Thereby, the microwave module 3 is ready for applying the new set of operation parameters

After all sets of operation parameter have been received at the respective microwave modules 3, the master control entity 5 transmits an acknowledge command to the microwave modules 3, as already explained before (S11). The receipt of said acknowledge command initiates the take over of operation parameters.

However, before taking over the operation parameters, the microwave modules 3 may optionally decrease transmission power (S12). For example, transmission power may be reduced to a certain percentage value, e.g. 10% of target transmission power. Said decrease is obtained by lowering the amplification factor within the microwave module 3. The decrease of transmission power may be triggered by the acknowledge command itself or by a separate trigger for decreasing transmission power.

After decreasing the transmission power, the change of operation parameters is carried out (S13). So, the respective microwave modules change from previously used operation parameters (e.g. a certain frequency, phase constellation) to new operation parameters.

After changing the operation parameters, the microwave modules 3 are driven based on the new sets of operation parameters and the transmission power may optionally increased to a target transmission power (S14). Said target transmission power may be indicated by a power value or amplification factor value included in the set of operation parameters.

During performing upper-mentioned steps of decreasing transmission power, taking over of operating parameters and increasing the transmission power, one or more massages can be provided from the respective microwave module 3 to the master control entity 5. Said messages may be set according to a handshaking procedure. For example, after reducing the transmission power, a message may be sent from each microwave module 3 to the master control entity 5 to confirm that the microwave module 3 is ready for operation parameter update. The master control entity 5 may send the acknowledge command to the microwave modules 3 only if all microwave modules 3 have confirmed readiness. Thereby, the master control entity 5 is informed about the procedures currently performed by the respective microwave module 3.

Preferably, during powering the microwave modules 3 at reduced power level, the microwave modules 3 perform a measurement regarding channel reverse power. Said measurement may be performed during operating the microwave module 3 with the new set of operation parameters. Said channel reverse power may be the power coupling back into the microwave module 3 due to electromagnetic waves received at the antenna of the microwave module 3. The microwave module 3 may transmit information regarding the channel reverse power to the master control entity 5. Thereby the master control entity 5 is able to check whether the channel reverse power of all microwave modules 3 is below a threshold value and therefore the new set of operating parameters can be also used at nominal transmission power (increased transmission power). If all microwave modules 3 show channel reverse power below threshold value, the master control entity 5 can initiate the increase of transmission power to nominal/target transmission power. However, if channel reverse power of one or more microwave modules 3 exceeds the threshold value, the new set of operating parameters cannot be used at nominal/target transmission power and the master control entity 5 has to initiate the transmission of further sets of operating parameters to the microwave modules 3.

Thereby, safe operation using multiple different sets of operation parameters can be ensured.

It should be noted that the description and drawings merely illustrate the principles of the proposed invention. Those skilled in the art will be able to implement various arrangements that, although not explicitly described or shown herein, embody the principles of the invention.

### LIST OF REFERENCE NUMERALS

1 microwave device
2 cavity
3 microwave module
3.1 control unit
3.2 voltage controlled oscillator
3.3 amplifier
3.4 monitoring entity
3.5 circulator
3.6 electrical load
4 antenna
5 master control entity
CH1-CH4 microwave channel
RP channel reverse power

1. Method for operating a microwave device, the microwave device comprising a cavity and multiple microwave modules configured to provide microwaves into said cavity, the method comprising the steps of:
providing multiple sets of operation parameters, each set of operation parameters being associated with a certain microwave module;
synchronously transmitting the sets of operation parameters to the respective microwave modules and immediately applying each said set of operation parameters within the respective microwave modules after receipt of said sets of operation parameters;
or
uploading the sets of operation parameters to the respective microwave modules and applying each said set of parameters within the respective microwave modules after receipt of an acknowledge command or after expiry of a certain time period.

2. Method according to claim 1, wherein each said set of operation parameters comprise frequency information, phase information, amplitude or amplification information and/or ON/OFF-status information.

3. Method according to claim 1, wherein uploading the sets of operation parameters to the respective microwave modules is performed in a sequential way.

4. Method according to claim 1, wherein the uploaded sets of operation parameters are buffered within the respective microwave modules.

5. Method according to claim 1, wherein the acknowledge command is transmitted via a serial communication channel or data bus.

6. Method according to claim 1, wherein the acknowledge command is transmitted via a trigger line or synchronization line reserved for synchronization purposes.

7. Method according to claim 1, wherein the acknowledge command initiates a take-over-routine within two or more of said microwave modules, wherein a said uploaded set of operation parameters is applied within a said microwave module.

8. Method according to claim 1, wherein transmission power of the microwave modules is reduced before applying the sets of operation parameters and transmission power of the microwave modules is increased after applying the set of operation parameters.

9. Method according to claim 1, wherein the microwave device comprises a master control entity and said master control entity receives information from one or more of said microwave modules, said information indicating that the one or more of said microwave modules are ready for taking over the respective set(s) of operation parameters.

10. Method according to claim 1, wherein after applying the sets of operation parameters, the microwave modules respectively monitor a channel reverse power at a reduced power level.

11. Method according to claim 10, wherein information regarding the channel reverse power is transmitted towards a master control entity.

12. Method according to claim 11, wherein the master control entity evaluates information regarding the channel reverse power from different ones of said microwave modules and initiates an increase of output power of the respective microwave modules to target output power if said evaluated information indicates that channel reverse power values of the microwave modules are below a certain threshold value.

13. Method according to claim 11, wherein the master control entity initiates transmission of further sets of operation parameters to the microwave modules if the evaluated information indicates that the channel reverse power of at least one of the microwave modules is above a certain threshold value.

14. Microwave device comprising a cavity and multiple microwave modules for providing microwaves within said cavity, a control entity configured to perform the following steps:
providing multiple sets of operation parameters, each set of operation parameters being associated with a certain microwave module;
simultaneously transmitting the sets of operation parameters to the respective microwave modules and synchronously applying the sets of parameters within the respective microwave modules after receipt of said sets of parameters;
or
uploading the sets of operation parameters to the respective microwave modules and applying the sets of parameters within the respective microwave modules after receipt of an acknowledge command or after expiry of a certain time period.

15. A microwave oven comprising: a cooking cavity; a master control entity; a first microwave module for delivering first microwave energy to the cooking cavity via a first channel; and a second microwave module for delivering second microwave energy to the cooking cavity via a second channel; the first microwave module having a first voltage controlled oscillator and a first amplifier both operatively controlled by a first microwave control unit adapted to operate them to control a frequency, phase and amplitude of the first microwave energy; the second microwave module having a second voltage controlled oscillator and a second amplifier both operatively controlled by a second microwave control unit adapted to operate them to control a frequency, phase and amplitude of the second microwave energy; said master control entity being operatively coupled to both the first and second microwave controllers and being configured to send thereto successive sets of operating parameters for generating the respective first and second microwave energies, each said successive set of operating parameters comprising first parameters to be executed by the first microwave control unit to generate the first microwave energy and second parameters to be executed by the second microwave control unit to generate the second microwave energy; wherein at least one of either:
said master control is further configured to transmit the respective first and second parameters, respectively, of each said successive set of operating parameters synchronously to the first and second microwave control units, or
said first and second microwave control units each are adapted to receive and buffer the respective first or second parameters of each said successive set of operating parameters transmitted from the master control entity, and then to implement them synchronously only upon being triggered by an acknowledge command sent subsequently and simultaneously to both the first and second microwave control units so that the buffered first and second parameters are synchronously implemented by the respective first and second microwave control units to adjust respectively the first and second microwave energies delivered to the cooking cavity;
and wherein the first and second microwave controllers are configured to reduce transmission power to reduced power levels of the first microwave energy and the second microwave energy, respectively, prior to implementing each said successive set of operating parameters, and to increase transmission power of the first microwave energy and the second microwave energy toward first and second target power values, respectively, after implementing of each said successive set of operating parameters.

16. The microwave oven according to claim 15, said first and second microwave modules being further configured to monitor and transmit to the master control entity information concerning reverse power values in the first and second channels, respectively, at the reduced power levels of the first and second microwave energies, wherein the master control entity is further configured to evaluate said information and to initiate the increase of transmission power of the respective first and second microwave modules toward the first and second target power values when said information indicates that reverse power values in the first and second channels are below respective thresholds or collectively below a collective threshold.

17. The microwave oven according to claim 16, the master control entity being further configured to transmit a next one of the successive sets of operating parameters to the first and second microwave control units when said information indicates that at least one said reverse power value is above its respective threshold or that the reverse power values in the first and second channels are collectively above the collective threshold.
